(19) United States
(12) Patent Application Publication
(10) Pub. No.: US 2011/0232166 A1
(43) Pub. Date: Sep. 29, 2011

(54) LOW OXYGEN BIOMASS-DERIVED PYROLYSIS OILS AND METHODS FOR PRODUCING THE SAME

(75) Inventor: Joseph A. Kocal, Glenview, IL (US)

(73) Assignee: UOP LLC, Des Plaines, IL (US)

(21) Appl. No.: 12/731,992

(22) Filed: Mar. 25, 2010

(51) Int. Cl. C10L 1/18

(52) U.S. Cl. 44/313

(57) ABSTRACT

Methods are provided for producing low oxygen biomass-derived pyrolysis oil from carbonaceous biomass feedstock. In an embodiment, hydrogen gas is produced in the presence of a low temperature reforming catalyst from hemicellulose extracted from the carbonaceous biomass feedstock. The carbonaceous biomass feedstock, both whole and hemicellulose-depleted, is pyrolyzed in the presence of a pyrolysis upgrading catalyst to produce char and pyrolysis gases comprising oxygenated hydrocarbons and steam. A portion of the oxygenated hydrocarbons are converted into hydrocarbons. A residual portion of the oxygenated hydrocarbons of the pyrolysis gases is deoxygenated with the hydrogen and optionally, additional hydrogen gas. A condensable portion of the pyrolysis gases is condensed into low oxygen biomass-derived pyrolysis oil.

### FIELD OF THE INVENTION

The present invention generally relates to biofuels and processes for producing biofuels, and more particularly relates to low oxygen biomass-derived pyrolysis oils and methods for producing the same.

### DESCRIPTION OF RELATED ART

Fast pyrolysis is a thermal process during which solid carbonaceous biomass feedstock, i.e., “biomass”, such as wood waste, agricultural waste, etc., is rapidly heated to pyrolysis temperatures of about 300° C. to about 800° C. in the absence of air using a pyrolysis reactor. Under these conditions, solid products, liquid products and gaseous pyrolysis products are formed. A condensable portion (vapors) of the gaseous pyrolysis products is condensed into biomass-derived pyrolysis oil. The conventional biomass-derived pyrolysis oil is generally thermally unstable, corrosive, and has a low energy density. The low energy density and poor thermal stability of the biomass-derived pyrolysis oil is attributable in large part to oxygenated hydrocarbons in the oil, which undergo secondary reactions during storage. Such oxygenated hydrocarbons include carboxylic acids, phenols, cresols, aldehydes, etc. The oxygenated hydrocarbons in the oil are derived from oxygenated hydrocarbons in the gaseous pyrolysis products produced during pyrolysis.

Biomass-derived pyrolysis oil can be burned directly as fuel for certain boiler and furnace applications, and can also serve as a potential feedstock in catalytic processes for the production of biofuels in petroleum refineries or in stand-alone process units. Biomass-derived pyrolysis oil has the potential to replace up to 60% of transportation fuels, thereby reducing the dependency on conventional petroleum and reducing its environmental impact. However, conversion of biomass-derived pyrolysis oil into such biofuels and chemicals requires partial or full deoxygenation of the biomass-derived pyrolysis oil. Deoxygenation can proceed via two main routes, namely the elimination of either water or CO₂. While some deoxygenation occurs from the elimination of carbon oxides during conventional pyrolysis of the carbonaceous biomass feedstock, such deoxygenation is insufficient to produce high energy density, thermally stable biomass-derived pyrolysis oils from which biofuels and chemicals are derived. Conversion also typically requires the addition of substantial amounts of hydrogen gas to deoxygenate by eliminating water.

Most efforts to deoxygenate the biomass-derived pyrolysis oils involve secondary upgrading of the biomass-derived pyrolysis oils after their production, i.e., post-pyrolysis. Such secondary upgrading adds unnecessary cost and complexity to the production of low oxygen biomass-derived pyrolysis oil.

Accordingly, it is desirable to provide methods for producing low oxygen biomass-derived pyrolysis oil during the pyrolysis process, thereby potentially eliminating or substantially reducing the need for secondary upgrading of the oils. It is also desirable to produce low oxygen biomass-derived pyrolysis oils having increased energy density, thermal stability and lower corrosivity. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

Methods are provided for producing low oxygen biomass-derived pyrolysis oil. In accordance with one exemplary embodiment, a method for producing the low oxygen biomass-derived pyrolysis oil comprises producing hydrogen gas in the presence of a low temperature reforming catalyst from hemicellulose extracted from hemicellulose-containing carbonaceous biomass feedstock. Carbonaceous biomass feedstock is pyrolyzed in the presence of a pyrolysis upgrading catalyst to produce char and pyrolysis gases comprising oxygenated hydrocarbons and steam and to convert a portion of the oxygenated hydrocarbons into hydrocarbons. A residual portion of the oxygenated hydrocarbons of the pyrolysis gases is deoxygenated into hydrocarbons with the hydrogen gas and optionally, additional hydrogen gas. A condensable portion of the pyrolysis gases is condensed into low oxygen biomass-derived pyrolysis oil.

A method is provided for producing low oxygen biomass-derived pyrolysis oil from hemicellulose-containing carbonaceous biomass feedstock in accordance with yet another exemplary embodiment of the present invention. The method comprises extracting hemicellulose from carbonaceous biomass feedstock to produce hemicellulose-depleted carbonaceous biomass feedstock and a hemicellulose extract. The hemicellulose extract is treated in the presence of a low temperature reforming catalyst to produce hydrogen gas. The hemicellulose-depleted carbonaceous biomass feedstock is introduced into a pyrolysis reactor maintained at pyrolysis temperatures to produce char and pyrolysis gases comprising oxygenated hydrocarbons, methane, and steam. The hydrogen gas is supplied to the pyrolysis reactor in the presence of a pyrolysis upgrading catalyst to deoxygenate at least a portion of the oxygenated hydrocarbons into hydrocarbons and to form water. A condensable portion of the pyrolysis gases is condensed into low oxygen biomass-derived pyrolysis oil.

A method is provided for reducing an oxygen level in condensable pyrolysis gases comprising oxygenated hydrocarbons and steam to produce low oxygen biomass-derived pyrolysis oil therefrom, in accordance with another exemplary embodiment of the present invention. The method comprises producing hydrogen gas by treating hemicellulose, and optionally producing additional hydrogen gas from steam reforming light oxygenated hydrocarbons, in the presence of a low temperature reforming catalyst. At least a portion of the oxygenated hydrocarbons in the condensable pyrolysis gases is deoxygenated in the presence of a pyrolysis upgrading catalyst with the hydrogen gas, and optionally, the additional hydrogen gas. The condensable pyrolysis gases are condensed into low oxygen biomass-derived pyrolysis oil.

### BRIEF DESCRIPTION OF THE DRAWINGS

The present invention will hereinafter be described in conjunction with the following drawing figures, wherein like numerals denote like elements, and wherein:

FIG. 1 is a flow chart of a method for producing low oxygen biomass-derived pyrolysis oils, according to exemplary embodiments of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various exemplary embodiments of the present invention are directed to low oxygen biomass-derived pyrolysis oils and methods for producing the same. The low oxygen biomass-derived pyrolysis oils produced according to exemplary embodiments of the present invention are substantially fully hydrocarbon products (i.e., products comprising only hydrogen and carbon atoms), making them more suitable for processing into biofuels and chemicals. The methods comprise producing hydrogen gas, in the presence of a low temperature reforming catalyst, from hemicellulose extracted from carbonaceous biomass feedstock (hereinafter “biomass”), and pyrolyzing whole or hemecellulose-depleted carbonaceous biomass feedstock in the presence of a pyrolysis upgrading catalyst to produce char and pyrolysis gases comprising oxygenated hydrocarbons, methane, and steam. The oxygenated hydrocarbons produced as pyrolysis intermediates are substantially deoxygenated by the hydrogen gas from the extracted hemicellulose to yield substantially fully hydrocarbon pyrolysis gases. A condensable portion of the substantially fully hydrocarbon pyrolysis gases is condensed into low oxygen biomass-derived pyrolysis oil. “Hydrocarbons” as used herein are organic compounds that contain principally only hydrogen and carbon, i.e., “hydrocarbons” are oxygen-free. “Oxygenated hydrocarbons” as used herein are organic compounds containing hydrogen, carbon, and oxygen.

It should be appreciated that while the oil produced according to exemplary embodiments of the present invention is generally described herein as a “low oxygen biomass-derived pyrolysis oil”, this term generally includes any oil produced having a lower oxygen concentration than conventional biomass-derived pyrolysis oil. The term “low oxygen biomass-derived pyrolysis oil” also includes oil having no oxygen.

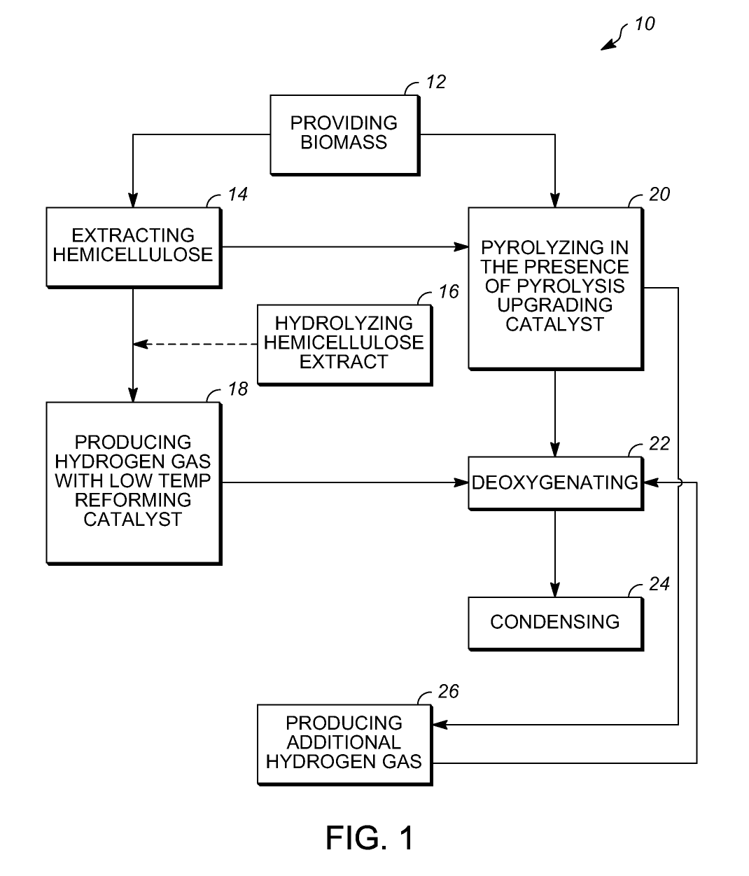

As shown in FIG. 1, in accordance with an exemplary embodiment, a method 10 for producing low oxygen biomass-derived pyrolysis oil begins by providing a hemicellulose-containing carbonaceous biomass feedstock (also referred to herein as “hemicellulose-containing biomass”) (step 12). Hemicellulose-containing carbonaceous biomass feedstock includes biomass material such as wood, agricultural wastes/residues, nuts and seeds, grasses, forestry residues, municipal solid waste, construction/demolition debris, cellulose, or the like.

Next, the hemicellulose is extracted from the hemicellulose-containing carbonaceous biomass feedstock to form hemicellulose-depleted carbonaceous biomass feedstock (hereinafter “hemicellulose-depleted biomass”) and a hemicellulose extract (step 14). The hemicellulose may be extracted using known extraction methods such as acid extractions, enzymatic extractions, or the like. Depending on the extraction method used, the extraction step may itself partially hydrolyze the hemicellulose to form sugars (primarily pentoses and hexoses). Alternatively, the method 10 may further comprise the optional step of at least partially hydrolyzing the hemicelluose extract using known hydrolysis methods (step 16) to form an at least partially hydrolyzed hemicellulose extract.

Hydrogen gas is produced by treating the hemicellulose extract in the presence of a low temperature reforming catalyst (step 18). The hemicellulose extract may be at least partially hydrolyzed. This producing hydrogen gas step may be performed in a hydrogen generator reactor at temperatures of about 150° C. to about 300° C. and at pressures of about 2068427 pascal to about 6894757 pascal (about 300 psig to about 1000 psig). The effective amount of the low temperature reforming catalyst to the at least partially hydrolyzed hemicellulose comprises about 0.1 to about 10 units per hour (LHSV). For example, when using a liter as the unit, the effective amount of the low temperature reforming catalyst is one liter of the at least partially hydrolyzed hemicellulose per liter of catalyst per hour. This example would be equivalent to 1 liquid hourly space velocity (LHSV).

As used herein, a “catalyst” is defined as solid material comprising at least an active phase. The catalyst may also comprise a support material. The support material acts as a locus for combining the catalyst components together; in some cases, the support material may also have catalytic activity. Optionally, one or more modifiers may be added to the catalyst. The modifiers may be, for example, a modifier element. These modifiers and/or additives serve to optimize the catalyst activity, selectivity, or stability for a specific application as hereinafter described.

The low temperature reforming catalyst comprises a Cerium (Ce)-based catalyst, a transition metal-based catalyst, or combinations thereof. Suitable exemplary transition metals in the transition metal-based catalyst include Chromium (Cr), Molybdenum (Mo), Tungsten (W), Vanadium (V), Niobium (Nb), Tantalum (Ta), Scandium (Sc), Yttrium (Y), and Lanthanum (La), and combinations thereof. The metal in the low temperature reforming catalyst comprises about 1 to about 20 weight percent. The metal may optionally be supported on a support material such as a metal oxide, silica carbide, carbon, and a combination thereof. Suitable exemplary metal oxides include alumina, silica-alumina, silica, zirconia, and titania, and combinations thereof. The low temperature reforming catalyst may have a modifier element in combination with the metal. Suitable exemplary modifier elements include alkali metals such as lithium (Li), sodium (Na), potassium (K), and cesium (Cs), alkaline earth metals such as magnesium (Mg), calcium (Ca), strontium (Sr), barium (Ba), and combinations thereof. The modifier element may be present in an amount from about 0.25 to about 5% by weight of the low temperature reforming catalyst. These modifier elements may attenuate the metal activity via impacting the electronic structure of the metals and/or decreasing the acidity of the support material.

The carbonaceous biomass feedstock (“biomass”) is pyrolyzed in, for example, a pyrolysis reactor in the presence of a pyrolysis upgrading catalyst (step 20). The pyrolysis step (step 20) can be performed before, after, or during the step of producing hydrogen (step 18). The carbonaceous biomass feedstock may be whole biomass or may be hemicellulose-depleted biomass from which the hemicellulose has been extracted. It should be appreciated that while the hemicellulose-depleted biomass produced according to exemplary embodiments of the present invention is generally described herein as a “hemicellulose-depeleted biomass”, this term generally includes any biomass produced having a lower hemicellulose content than conventional biomass. The term “hemicellulose-depleted carbonaceous biomass feedstock” also includes biomass from which all hemicellulose has been extracted. Preferably, substantially all of the hemicellulose is extracted from the carbonaceous biomass feedstock. The whole biomass may include biomass that does not include hemicellulose, for example, lignin or algae.

The whole or hemicellulose-depleted biomass is pyrolyzed at pyrolysis temperatures of about 300° C. to about 800° C. in the presence of a pyrolysis upgrading catalyst for a sufficient time to produce char and pyrolysis gases comprising a variety of oxygenated hydrocarbons, heavy (greater than C₆) hydrocarbons which include partially depolymerized biomass and light (C₁-C₄) hydrocarbons, carbon oxides such as carbon dioxide and carbon monoxide (collectively “carbon oxides”), hydrogen gas, and steam. The oxygenated hydrocarbons include carboxylic acids, phenols, cresols, aldehydes, etc., that contribute to the thermal instability and corrosivity of conventional pyrolysis products.

In the presence of the pyrolysis upgrading catalyst, a portion of the oxygenated hydrocarbons are converted into hydrocarbons and form hydrogen gas and carbon oxides in the pyrolysis gases. The oxygen contained in the oxygenated hydrocarbons is removed as carbon oxides and water. Removal of the oxygen from oxygenated hydrocarbons converts them into hydrocarbons. In addition, in the presence of the pyrolysis upgrading catalyst, at least a portion of the heavy hydrocarbons in the pyrolysis gases are depolymerized to form lighter hydrocarbons that are within fuel range, for example, gasoline and diesel are within fuel range.

In one embodiment, the effective amount of the pyrolysis upgrading catalyst is expressed in a catalyst-to-biomass ratio of about 0.25 to about 10 by weight. The pyrolysis upgrading catalyst may be a hydroprocessing catalyst supported on a support material, a zeolitic catalyst, a basic catalyst, a transition metal-based catalyst, an ore catalyst, or combinations thereof. Suitable exemplary hydroprocessing catalysts include Ni/Mo catalysts, Co/Mo catalysts, Ni/W catalysts, Co/W catalysts, and combinations thereof. Suitable exemplary support materials comprise a metal oxide such as alumina, silica-alumina, silica, zirconia, and titania, a silica carbide, carbon, and combinations thereof. The zeolitic catalyst may have a structure type selected from the group consisting of Faujasite (FAU), MFI, Beta (BEA), and combinations thereof. The zeolitic catalyst may include an impregnated metal. Such impregnated metals include nickel (Ni), palladium (Pd), platinum (Pt), rhodium (Rh), ruthenium (Ru), Iridium (Ir), gallium (Ga), zinc (Zn), and combinations thereof. These impregnated metals may promote deoxygenation. In addition to their use as a catalyst, the zeolites may be used as a support material for the hydroprocessing catalysts and the transition metal-based catalysts. Suitable exemplary basic catalysts include magnesium oxide (MgO), calcium oxide (CaO), Cs—X wherein X is an X zeolite, hydrotalcite, and combinations thereof. The transition metal-based catalyst may be supported on a support material. Exemplary suitable transition metals for the transition metal-based catalysts include nickel (Ni), palladium (Pd), platinum (Pt), rhodium (Rh), ruthenium (Ru), Iridium (Ir), and combinations thereof. The support material for the transition metal-based catalysts may include a metal oxide such as alumina, silica-alumina, silica, zirconia, and titania, a silica carbide, carbon, and combinations thereof. Exemplary suitable ore catalysts include an aluminum ore, a borate ore, a silicate ore, and combinations thereof, and containing a metal oxide (MO), wherein M is iron (Fe), nickel (Ni), cobalt (Co), and combinations thereof. A preferred ore catalyst is Bauxite, an alumina ore containing iron oxides. The ore to metal ratio comprises about 10 to 1.

The whole or hemicellulose-depleted biomass may be pyrolyzed using various pyrolysis methods. For example, fast pyrolysis methods of rapidly imparting a relatively high temperature to feedstocks for a very short residence time, then rapidly reducing the temperature of the pyrolysis products before chemical equilibrium can occur are preferred. By this approach, the complex structures of the biomass are broken into reactive chemical fragments which are initially formed by depolymerization and volatilization reactions, but do not persist for any significant length of time. Fast pyrolysis is an intense, short duration process that can be carried out in a variety of pyrolyis reactors such as fixed bed pyrolysis reactors, fluidized bed pyrolysis reactors, circulating fluidized bed reactors (CFBR), or other pyrolysis reactors capable of fast pyrolysis as known in the art. For example, in an exemplary fluidized bed pyrolysis reactor, carbonaceous biomass feedstock is thermally converted (i.e., pyrolyzed) at pyrolysis temperatures of about 300° C. to about 800° C. in the presence of a heat transfer medium. The heat transfer medium comprises inert solids such as sand, catalytic solids, or a combination thereof. Here, the catalytic solids may comprise the pyrolysis upgrading catalyst. The heat transfer medium is provided in a fluidized state and maintained at a temperature suitable for pyrolysis to pyrolyze the carbonaceous biomass feedstock. The heat transfer medium is fluidized by a fluidizing gas. The heat transfer medium forms a fluidized bed within the pyrolysis reactor. The step of pyrolyzing the carbonaceous biomass feedstock in the presence of the pyrolysis upgrading catalyst comprises contacting the carbonaceous biomass feedstock and/or pyrolysis gases with the catalyst. It is to be understood that the fast pyrolysis methods described above are exemplary. The exemplary embodiments are not limited to fast pyrolysis methods, any particular pyrolysis system, method, or pyrolysis reactor.

As step 20 converts only a portion of the oxygenated hydrocarbons into hydrocarbons, a residual portion of oxygenated hydrocarbons remains in the pyrolysis gases. Accordingly, method 10 continues with deoxygenating at least a residual portion of the oxygenated hydrocarbons in the pyrolysis gases (step 22). Conversion of the residual oxygenated hydrocarbons in the pyrolysis gases into hydrocarbons requires a source of hydrogen gas. The hydrogen gas produced from step 18 may be supplied into the pyrolysis reactor to convert (deoxygenate) at least a portion of the residual oxygenated hydrocarbons into hydrocarbons. Preferably, substantially all of the oxygenated hydrocarbons are converted into hydrocarbons. While FIG. 1 shows steps 20 and 22 as separate subsequent steps for illustrative purposes, it will be understood that pyrolyzing (step 20) and deoxygenating (step 22) are being performed substantially simultaneously in the pyrolysis reactor. Deoxygenating (step 22) may alternatively or additionally be performed in a hydroprocessing reactor (not shown).

In one embodiment, additional hydrogen gas to supply to the pyrolysis reactor or the hydroprocessing reactor for deoxygenating the residual portion of the oxygenated hydrocarbons therein may be produced (step 26) by introducing at least a portion of the light oxygenated hydrocarbons (C₁-C₄) produced during pyrolysis into the hydrogen generator reactor and steam reforming the light oxygenated hydrocarbons in the presence of a steam reforming catalyst. Conventional and non-conventional steam reforming catalysts may be used. An exemplary steam reforming reaction with an exemplary light oxygenated hydrocarbon, acetaldehyde, is as follows: CH₃C(O)H+3H₂O→5H₂+2CO₂. The light oxygenated hydrocarbons are separated from the heavier oxygenated hydrocarbons prior to introduction into the hydrogen generator reactor. The light oxygenated hydrocarbons may be separated by fractionation or the like. The heavier oxygenated hydrocarbons are not introduced into the hydrogen generator reactor as they tend to make low temperature reforming catalysts unstable, i.e., the low temperature reforming catalysts may deactivate over time because of carbon deposits formed on the catalyst from the heavier hydrocarbons.

Once the whole biomass or hemicellulose-depleted biomass has been pryolyzed and substantially deoxygenated, solid char and pyrolysis gases comprising the condensable portion (vapors) and the non-condensable portion exit the pyrolysis reactor. The heat transfer medium and solid char is separated from the pyrolysis gases. The pyrolysis gases are passed to a condenser (not shown) or series of condensers where they are condensed, with the non-condensable portion thereof continuing for further processing or use. The non-condensable portion of the pyrolysis gases comprises hydrogen gas, methane, and carbon oxides.

The condensable portion (vapors) of the pyrolysis gases comprising hydrocarbons and any residual oxygenated hydrocarbons are condensed in the condenser into low oxygen biomass-derived pyrolysis oil having substantially improved energy density, lower corrosivity, and higher thermal stability than conventional biomass-derived pyrolysis oil (step 100). The low oxygen biomass-derived pyrolysis oil has potential for use as a biofuel or chemical potentially eliminating the need for or substantially reducing the severity of secondary upgrading to remove oxygen therefrom as is needed with conventional biomass-derived pyrolysis oils.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for producing low oxygen biomass-derived pyrolysis oil from carbonaceous biomass feedstock, the method comprising the steps of:
producing hydrogen gas in the presence of a low temperature reforming catalyst from hemicellulose extracted from hemicellulose-containing carbonaceous biomass feedstock;
pyrolyzing carbonaceous biomass feedstock in the presence of a pyrolysis upgrading catalyst to produce char and pyrolysis gases comprising oxygenated hydrocarbons and steam and to convert a portion of the oxygenated hydrocarbons into hydrocarbons;
deoxygenating a residual portion of the oxygenated hydrocarbons of the pyrolysis gases with the hydrogen gas and optionally, additional hydrogen gas;
condensing a condensable portion of the pyrolysis gases into low oxygen biomass-derived pyrolysis oil.

2. The method of claim 1, wherein the step of producing hydrogen gas comprises producing hydrogen gas from at least partially hydrolyzed hemicellulose.

3. The method of claim 1, wherein the step of producing hydrogen gas comprises producing the hydrogen gas in the presence of a low temperature reforming catalyst comprising a Cerium (Ce)-based catalyst, a transition metal-based catalyst, or combinations thereof, a transition metal of the transition metal-based catalyst selected from the group consisting of Chromium (Cr), Molybdenum (Mo), Tungsten (W), Vanadium (V), Niobium (Nb), Tantalum (Ta), Scandium (Sc), Yttrium (Y), and Lanthanum (La), and combinations thereof, the Cerium and the transition metal comprising about 1 to about 20 weight percent of the low temperature reforming catalyst.

4. The method of claim 3, wherein the step of producing hydrogen gas comprises producing the hydrogen gas in the presence of the low temperature reforming catalyst supported on a support material, the support material comprising a metal oxide selected from the group consisting of alumina, silica-alumina, silica, zirconia, and titania, silica carbide, carbon, and a combination thereof.

5. The method of claim 3, wherein the step of producing hydrogen gas comprises producing the hydrogen gas in the presence of the low temperature reforming catalyst having a modifier element in combination with the Cerium, the transition metal, or both, the modifier element comprising at least one of alkali and alkaline earth metals selected from the group consisting of lithium (Li), sodium (Na), potassium (K), cesium (Cs), magnesium (Mg), calcium (Ca), strontium (Sr), barium (Ba), and combinations thereof, the modifier element in an amount from about 0.25 to about 5% by weight of the low temperature reforming catalyst.

6. The method of claim 1, wherein the step of producing hydrogen gas comprises producing hydrogen gas at temperatures of about 150° C. to about 300° C. and at pressures of about 2068427 pascal to about 6894757 pascal (about 300 psig to about 1000 psig) in a hydrogen generator reactor.

7. The method of claim 1, wherein the step of pyrolyzing the carbonaceous biomass feedstock comprises pyrolyzing the carbonaceous biomass feedstock in the presence of a pyrolysis upgrading catalyst selected from the group consisting of a hydroprocessing catalyst, a zeolitic catalyst, a basic catalyst, a transition metal-based catalyst, an ore catalyst, and combinations thereof.

8. The method of claim 7, wherein the step of pyrolyzing the carbonaceous biomass feedstock comprises pyrolyzing the carbonaceous biomass feedstock in the presence of the hydroprocessing catalyst supported on a support material, the hydroprocessing catalyst selected from the group consisting of Ni/Mo, Co/Mo, Ni/W, Co/W, and combinations thereof, and the support material comprising a metal oxide selected from the group consisting of alumina, silica-alumina, silica, zirconia, and titania, silica carbide, carbon, and combinations thereof.

9. The method of claim 7, wherein the step of pyrolyzing the carbonaceous biomass feedstock comprises pyrolyzing the carbonaceous biomass feedstock in the presence of the zeolitic catalyst having a structure type selected from the group consisting of FAU, MFI, BEA, and combinations thereof, and the zeolitic catalyst having a modifier element selected from the group consisting of nickel (Ni), palladium (Pd), platinum (Pt), rhodium (Rh), ruthenium (Ru), Iridium (Ir), gallium (Ga), zinc (Zn), and combinations thereof.

10. The method of claim 7, wherein the step of pyrolyzing the carbonaceous biomass feedstock comprises pyrolyzing the carbonaceous biomass feedstock in the presence of the basic catalyst selected from the group consisting of magnesium oxide (MgO), calcium oxide (CaO), Cesium (Cs)-Zeolite X, hydrotalcite, and combinations thereof.

11. The method of claim 7, wherein the step of pyrolyzing the carbonaceous biomass feedstock comprises pyrolyzing in the presence of a transition metal-based catalyst supported on a support material, a transition metal of the transition metal-based catalyst selected from the group consisting of nickel (Ni), palladium (Pd), platinum (Pt), rhodium (Rh), ruthenium (Ru), Iridium (Ir), and combinations thereof, and the support material comprising a metal oxide selected from the group consisting of alumina, silica-alumina, silica, zirconia, and titania, silica carbide, carbon, and combinations thereof.

12. The method of claim 7, wherein the step of pyrolyzing the carbonaceous biomass feedstock comprises pyrolyzing the carbonaceous biomass feedstock in the presence of the ore catalyst selected from the group consisting of an aluminum ore, a borate ore, a silicate ore, and combinations thereof, and containing a metal oxide (MO) wherein M is selected from the group consisting of iron (Fe), nickel (Ni), cobalt (Co), and combinations thereof, and the ratio of metal oxide to the ore catalyst comprises about 1 to about 10 by weight.

13. The method of claim 1, wherein the step of deoxygenating a residual portion of the oxygenated hydrocarbons with additional hydrogen gas comprises deoxygenating with additional hydrogen gas produced by steam reforming at least a portion of light oxygenated hydrocarbons in the pyrolysis gases in the presence of the low temperature reforming catalyst.

14. A method for producing low oxygen biomass-derived pyrolysis oil from hemicellulose-containing carbonaceous biomass feedstock, comprising the steps of:
extracting hemicellulose from carbonaceous biomass feedstock to produce hemicellulose-depleted carbonaceous biomass feedstock and a hemicellulose extract;
treating the hemicellulose extract in the presence of a low temperature reforming catalyst to produce hydrogen gas;
introducing the hemicellulose-depleted carbonaceous biomass feedstock into a pyrolysis reactor maintained at pyrolysis temperatures in the presence of a pyrolysis upgrading catalyst to produce char and pyrolysis gases comprising oxygenated hydrocarbons, methane, and steam;
supplying the hydrogen gas to the pyrolysis reactor to deoxygenate at least a portion of the oxygenated hydrocarbons into hydrocarbons and to form water; and
condensing a condensable portion of the pyrolysis gases into low oxygen biomass-derived pyrolysis oil.

15. The method of claim 14, wherein the step of extracting hemicellulose from the carbonaceous biomass feedstock comprises at least partially hydrolyzing the hemicellulose extract.

16. The method of claim 14, further comprising the step of at least partially hydrolyzing the hemicellulose extract after the extracting step and prior to the treating step.

17. The method of claim 14, wherein the step of treating the hemicellulose extract in the presence of a low temperature reforming catalyst to produce hydrogen gas comprises treating the hemicellulose extract at temperatures of about 150° C. to about 300° C. and at pressures of about 2068427 pascal to about 6894757 pascal (300 psig to about 1000 psig) in a hydrogen generator reactor.

18. The method of claim 14, wherein the step of treating the hemicellulose extract comprises treating the hemicellulose extract in the presence of the low temperature reforming catalyst comprising a Cerium (Ce)-based catalyst, a transition metal-based catalyst, or combinations thereof, a transition metal of the transition metal-based catalyst selected from the group consisting of Chromium (Cr), Molybdenum (Mo), Tungsten (W), Vanadium (V), Niobium (Nb), Tantalum (Ta), Scandium (Sc), Yttrium (Y), and Lanthanum (La), and combinations thereof, the Cerium and the transition metal comprising about 1 to about 20 weight percent of the low temperature reforming catalyst, the low temperature reforming catalyst optionally supported on a support material, the support material comprising a metal oxide selected from the group consisting of alumina, silica-alumina, silica, zirconia, and titania, silica carbide, carbon, and a combination thereof and optionally having a modifier element in combination with the Cerium, the transition metal, or both, the modifier element comprising at least one of alkali and alkaline earth metals selected from the group consisting of lithium (Li), sodium (Na), potassium (K), cesium (Cs), magnesium (Mg), calcium (Ca), strontium (Sr), barium (Ba), and combinations thereof, the modifier element in an amount from about 0.25 to about 5% by weight of the low temperature reforming catalyst.

19. The method of claim 14, wherein the step of introducing the hemicellulose-depleted carbonaceous biomass feedstock into the pyrolysis reactor comprises introducing the hemicellulose-depleted carbonaceous biomass feedstock into the pyrolysis reactor in the presence of a pyrolysis upgrading catalyst comprising a hydroprocessing catalyst supported on a support material, a zeolitic catalyst, a basic catalyst, a transition metal-based catalyst, and an ore catalyst, or combinations thereof, the hydroprocessing catalyst selected from the group consisting of Ni/Mo, Co/Mo, Ni/W, Co/W, and combinations thereof, and the support material comprising a metal oxide selected from the group consisting of alumina, silica-alumina, silica, zirconia, and titania, silica carbide, carbon, and combinations thereof, the zeolitic catalyst having a structure type selected from the group consisting of FAU, MFI, BEA, and combinations thereof and having a modifier element selected from the group consisting of nickel (Ni), palladium (Pd), platinum (Pt), rhodium (Rh), ruthenium (Ru), Iridium (Ir), gallium (Ga), zinc (Zn), and combinations thereof, the basic catalyst selected from the group consisting of magnesium oxide (MgO), calcium oxide (CaO), Cs—X wherein X is zeolite X faujasite, hydrotalcite, and combinations thereof, the transition metal-based catalyst supported on a support material, a transition metal of the transition metal-based catalyst selected from the group consisting of nickel (Ni), palladium (Pd), platinum (Pt), rhodium (Rh), ruthenium (Ru), Iridium (Ir), and combinations thereof, and the support material comprising a metal oxide selected from the group consisting of alumina, silica-alumina, silica, zirconia, and titania, silica carbide, carbon, and combinations thereof, and the ore catalyst selected from the group consisting of an aluminum ore, a borate ore, a silicate ore, and combinations thereof, and containing a metal oxide (MO) wherein M is selected from the group consisting of iron (Fe), nickel (Ni), cobalt (Co), and combinations thereof, and the ratio of the pyrolysis upgrading catalyst to the hemicellulose-depleted carbonaceous biomass feedstock is about 0.1 to about 10, by weight.

20. A method for reducing an oxygen level in condensable pyrolysis gases comprising oxygenated hydrocarbons and steam to produce low oxygen biomass-derived pyrolysis oil therefrom, comprising the steps of:
producing hydrogen gas from hemicellulose, and optionally, producing additional hydrogen from steam reforming light oxygenated hydrocarbons, in the presence of a low temperature reforming catalyst;
deoxygenating at least a portion of the oxygenated hydrocarbons in the condensable pyrolysis gases in the presence of a pyrolysis upgrading catalyst with the hydrogen gas and optionally, the additional hydrogen gas; and
condensing the condensable pyrolysis gases into low oxygen biomass-derived pyrolysis oil.
